(19) United States
(12) Patent Application Publication
(10) Pub. No.: US 2005/0027627 A1
(43) Pub. Date: Feb. 3, 2005

(54) System and methods for enrolling participants in voluntary benefit plans

(75) Inventors: Russell K. Lemken JR., West Des Moines, IA (US); Jeanne A. Johnson, Ankeny, IA (US); Karen S. Larson, Urbandale, IA (US)

Correspondence Address: MCKEE, VOORHEES & SEASE, P.L.C., 801 GRAND AVENUE, SUITE 3200, DES MOINES, IA, 50309-2721, US

(73) Assignee: PRINCIPAL FINANCIAL SERVICES, INC, Des Moines, IA (US)

(21) Appl. No.: 10/851,366

(22) Filed: May 21, 2004

Related U.S. Application Data
(60) Provisional application No. 60/472,539, filed on May 21, 2003.

(51) Int. Cl. G06F 17/60

(52) U.S. Cl. 705/35; 705/1

(57) ABSTRACT

A system and method for enrolling participants in a retirement plan simplifies election decisions necessary to enroll in the retirement plan and encourages retirement savings through use of the retirement plan. An enrollment form is provided to participants, the enrollment form includes a convenience election option whereby if the participant selects the convenience election option then does not specify the allocation of investments into funds. The enrollment form is processed and if the convenience election option is selected the participants contributions are allocated into funds based on the expected retirement age of the participant.

### PRIORITY STATEMENT

This application claims priority to U.S. Provisional Application No. 60/472,539 filed on May 21, 2003, hereby incorporated by reference in its entirety.

### BACKGROUND OF THE INVENTION

1. Field of the Invention

The present invention relates to financial services and voluntary benefit plans. More particularly, though not exclusively, the present invention relates to a system and method for enrolling participants in defined contribution plans, reducing or eliminating the confusion and complexity eligible employees face during the enrollment process by bundling multiple election decisions in a unique and novel fashion.

2. Problems in the Art

Employers today face a number of challenges in managing productivity and efficiency, including uncovering ways to reduce business taxes, keep employee benefit costs low, and hire and retain quality employees. Not surprisingly, many employers have turned to group retirement plans as part of a compensation package to attract quality employees while encouraging employee loyalty, thereby reducing the time employers spend hiring and training.

The process of enrolling new employees or participants into a group retirement plan has proved problematic, however. This is particularly true in the case of defined contribution plans that require the participant to make a series of elections about their contributions. For instance, eligible employees must make election decisions about deferral levels, fund choices, allocation percentages, etc. Many eligible employees are daunted by the wide array of decisions. These factors prevent many people from taking the necessary steps to be prepared for retirement. In fact, according to industry research, participation rates for defined contribution plans have declined significantly in recent years.

In an effort to reduce the number of election decisions eligible employees must make during the enrollment process, some firms provide for “automatic enrollment” (also known as “negative election enrollment”). In automatic enrollment, the employer enrolls all employees on a de facto basis, normally without an enrollment meeting. The employees can decide to change their participation or opt-out of the plan at a later date. Automatic enrollment has a very low usage rate (less than 10%) among plan sponsors and usually characterized by low default deferral rates (2%-3% typically) and a single, conservative investment option (e.g., money market, or stable value). Such low deferral rates and conservative investment options are not appropriate for most employees. Simply put, a “one-size-fits-all” set of election decisions is neither optimal nor appropriate for most employees. To make matters worse, most employees neither review nor modify the default elections after the automatic enrollment process is complete. As such, many employees participate in define contribution pension plans for years by contributing at inappropriate deferral levels and investing in funds with relatively low yields.

Therefore, it is a primary object, feature or advantage of the present invention to provide a system and methods for enrolling eligible employees in defined contribution pension plans that overcomes the problems and deficiencies found in the prior art.

It is a further object, feature or advantage of the present invention is to overcome the inertia, procrastination and fear faced by many eligible employees by providing an enhanced, bundled, easy-to-use enrollment service.

A still further object, feature or advantage of the present invention is to assist plan participants in making appropriate election decisions with minimal effort.

Another feature, object or advantage of the present invention is to provide a simplified enrollment process with a default deferral rate to maximize any employer-matching contributions.

Yet another object, feature or advantage of the present invention is the provision of an enrollment process that provides for an age-appropriate investment allocation and portfolio.

These and/or other objects, features and advantages of the present invention will become apparent from the specification and claims that follow.

### SUMMARY OF THE INVENTION

The present invention provides a simplified, streamlined enrollment process for defined contribution plans. The system and methods provided reduce the confusion and complexity eligible employee's face during the enrollment process by bundling multiple election decisions into a single, easy to understand enrollment option. A single, easy to understand enrollment option can set an employees contributions to a default deferral rate unless otherwise specified. The default deferral rate is preferably equal to the deferral rate required to maximize any employer matching contribution. The default deferral rate can be set higher, as well. For example, one form of the invention could have a deferral rate which is the greater of 6% or the amount needed to maximize employer matching contributions, if applicable. To simplify the enrollment process, instead of requiring the employee to specify investment allocation, participant funds are allocated to an age-appropriate find or portfolio based upon the anticipated retirement age of the participant. Based upon the disclosure provided herein, persons skilled in the art will recognize that the present invention goes beyond simply providing pension plans to address the nation's retirement saving challenge—employee fear, missteps and inaction. It enhances the benefits offered by automating, simplifying and guiding the employee decision-making. The results are increased savings and more confident employees that can retire securely.

According to one aspect of the present invention, the present invention provides a computer-assisted method of enrolling eligible employees in a group retirement plan to simplify election decisions necessary to enroll in the group retirement plan and encourage appropriate election decisions. According to this method of the present invention, first an enrollment form is provided to an eligible employee. There is an “easy” or convenience election option associated with the enrollment form. According to the methodology of this aspect of the invention, the enrollment form is processed to enroll the eligible employee in the group retirement plan. Where the convenience election option is selected, a default deferral rate is assigned and funds are allocated based on the anticipated retirement age of the eligible employee. The present invention contemplates selecting a default deferral rate to maximize any employer matching contributions. The present invention also provides for allowing the convenience election option to include a further option to step up the deferral rate on a periodic basis, such as annually. The present invention contemplates automatic adjustment of allocation of funds over time as the employee ages and the time until retire.

According to another aspect of the present invention, a computer-assisted method of enrolling a participant in a retirement plan without receiving elections by the participant of investment options is disclosed. This method provides for receiving an age of the participant, receiving an expected retirement age of the participant, and determining at least one investment option for the participant based on the age of the participant and the retirement age of the participant. The method provides for determining an allocation of funds within the at least one investment option based on the age of the participant and the expected retirement age of the participant. The method provides for investing fund of the participant according to the allocation. The method also provides for automatically reallocating the funds to the participant over time. According to this aspect of the present invention, a deferral level to maximize contributions from a sponsor of the participant can also be determined. This deferral level can be associated with the convenience election by the participant. Thus, unless the participant specifies otherwise, this deferral level is selected by the participant. This aspect of the present invention also provides for associating a periodic step-up of the deferral level. Thus, the participant can select to automatically step-up their contributions over time.

According to another aspect of the present invention, a method of enrolling a participant in a group retirement plan that simplifies election decisions necessary to enroll in a group retirement plan and encourage retirement savings through the group retirement plan is disclosed. According to this method, an enrollment form is provided to participants. The enrollment form includes a convenience election option. When the participant selects the convenience election option, the participant does not need to specify the allocation of investment into funds. The enrollment form is in process to enroll the participant. The step of processing includes determining if the convenience election option is selected and where the convenience election option is selected, allocating funds of the participant based on the age of the participant. The enrollment form can include a second election option where the participant specifies the allocation of investments into funds. The enrollment form can include a third election option where the participant elects not to enroll. Where the enrollment form includes an election option for the participant to elect not to enroll, the enrollment form preferably includes a verbal warning or graphical cue to discourage the participant from selecting not to participate.

Another aspect of the present invention relates to a system for enrolling a participant in a group retirement plan to simplify election decisions necessary to enroll in the group retirement plan and encourage savings in a participant account within the group retirement form. This system includes an enrollment form having a convenience election option whereby the participant selecting the convenience election option does not specify allocation of investment into funds. The system also includes a processing means for processing information associated with the enrollment form, the processing means adapted for allocating investment by the participant into at least one fund based on age of the participant and expected retirement age of the participant.

### BRIEF DESCRIPTION OF THE DRAWINGS

The present invention is illustrated by way of example and not limitation in the figures of the accompanying drawings, and in which:

FIG. 1 is a diagram showing information flow according to one embodiment of the present invention.

FIG. 2 is a pictorial representation of one embodiment of an enrollment form according to the present invention.

### DETAILED DESCRIPTION OF THE PREFERRED EMBODIMENT

The present invention will be described as it applies to a preferred embodiment. It is not intended that the present invention be limited to the described embodiment. It is intended that the invention cover all modifications and alternatives which may be included within the spirit and scope of the invention.

The preferred embodiment is directed to a system and methods for enrolling eligible employees in a 401(k) retirement plan, a popular defined contribution pension plan. Those skilled in the art will recognize that the system and methods disclosed as part of the preferred embodiment can be easily adapted for other types of pension plans, including both qualified and non-qualified plans. Moreover, one skilled in the art will recognize that the present invention can be used with any number of defined contribution plans, as well as other benefit plans offered on a voluntary enrollment basis, like voluntary life, disability income, dental, and/or other specialty insurance programs.

The enrollment process of the present invention includes a customer-facing business process and the attendant marketing and educational materials, service agreements, enrollment presentation scripts and forms needed to implement a simplified, streamlined enrollment process for defined contribution plans. Those skilled in the art will appreciate that the specific technology necessary to support this business process can take many forms well-known in the art.

The present invention reduces the confusion and complexity that eligible employees face during the enrollment process by bundling the multiple election decisions employees must make into a single, easy to understand option that allows them to enroll, often times by checking a single box on a form or similar variant thereof. The default deferral rate is set in advance for the enrollment option and is preferably equal to the deferral required to maximize any employer matching contribution. The default deferral rate can also be set higher, as well. For example, the deferral rate could equal the greater of 6% or the deferral required to maximize any employer matching contribution. This would also handle the situation where the employer does not provide a matching contribution. The enrollment process can also include a “step up” feature that allows participants to select to increase their deferral rate automatically by a certain amount (e.g. 1%) per year for a given number of years. This feature differs from other automatic deferral increase features in that it is not tied to pay increases and thus is significantly easier to administer and understand and a more reliable way to boost savings rates over time despite the typical participant inertia.

Participant funds are preferably allocated to a single, age-appropriate fund based upon the anticipated retirement age of the participant. Such an investment strategy will automatically adjust and rebalance the participant's account over time as the participant grows older and reaches nearer the retirement age. As an alternative, the participant's account can be invested in more than one fund or investment type. Such age-appropriate investment strategies are well-known in the art, but generally not known to participants who are investing in one or more funds associated with their retirement account.

Those skilled in the art will recognize that other investment strategies not necessarily tied to participant's retirement age can also be used. The default settings described above are agreed upon by the employer in advance of an initial enrollment meeting and stipulated in a plan service agreement.

The steps to bundle enrollment options or elections together make it possible for an eligible employee to enroll in the defined contribution plan with only minimal effort, such as by checking a single box on an enrollment form and entering a planned retirement age.

In a preferred embodiment, the present invention also allows employees to enroll in a more traditional way, making all election decisions separately or opting out of the plan entirely. That is, the new enrollment process described herein can be offered as an option, and not in place of, allowing eligible employees to make all of the election decisions.

Another feature of the present invention are one or more graphical cues on the enrollment form (which can be in hard copy or electronic form) that indicate the relative ease or complexity of different enrollment options offered and that highlight the disadvantages of opting out of the plan entirely. For example, in a preferred form of the invention the enrollment form includes these main options. The first option is a “Smart Start” enrollment option that includes default deferral rates and investment allocations as described above. The second option is a “Custom Enrollment” option wherein the participant selects a particular deferral rate and investment mix. This third option allows the participant to decline deferrals to the plan. A stop sign, a type of graphical cue, is positioned on the form near the third option. The stop sign helps impress upon the participant to think carefully before choosing not to save for retirement through participation in the employer-sponsored retirement plan. This particular graphical cue, a stop sign, is exemplary only. Those skilled in the art will appreciate that various graphical cues could be used with any of the options.

In a preferred form, the present invention also automatically signs up new participants for a review session with a resource consultant who can answer the participant's questions and provide additional assistance and education, if necessary. The resource consultant can also refer the participant to a full-service advisor if that service is needed and requested.

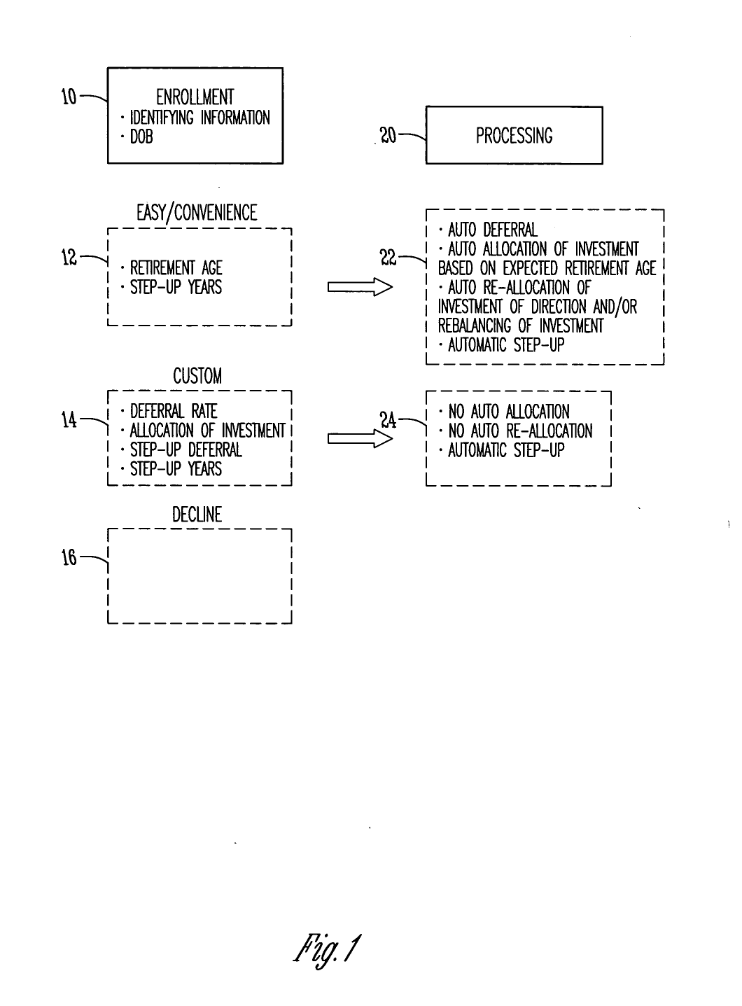

FIG. 1 illustrates one embodiment of information flow according to one aspect of the present invention. In FIG. 1, information flow is shown between the enrollment form 10 and a processing means 20. The enrollment form provides for collection of general information such as identifying information for a person and date of birth of the person. The enrollment form 10 preferably includes three election options. The first election option is the “easy” or convenience election option 12. The easy election option 12 allows a plan participant to enroll in the group retirement plan without needing to specify the allocation of investments. Instead, by relying upon the age or date of birth of the participant as well as the expected retirement age of the participant, the processing means 20 provides for automatic allocation of the participants investment based on the participant's age and their expected retirement age. The processing means 20 also provides for automatic re-allocation of investment direction and/or rebalancing of the investment over time as the participant ages. When the participant selects the easy or the convenience election option, the participant may also specify a deferral rate that the deferral rate should be stepped-up over time. Where the participant elects to step-up the deferral rate over time, the processing means 20 can provide for automatic step-up of the deferral rate in accordance with the participant's election. The present invention also contemplates that the easy or convenience election includes a default deferral rate. Preferably the default deferral rate is selected to maximize the contribution of a group retirement plan sponsor to a retirement account of the participant. For example, if the group retirement plan sponsor, such as an employer, matches up to 6% of the contributions of retirement fund made by its employees, then a default deferral rate for one of the employees would be 6% as this would be an amount that would maximize the employer's contribution to the retirement fund or account of the employee.

The enrollment form 10 can also include a custom election option 14. The custom election option 14 allows the participant to customize their investment direction or allocation of their investment. The custom option 14 also allows the participant to specify their deferral rate as well as a step-up deferral rate. It should be appreciated that if a participant elects the custom option 14, the participant will be required to enter additional information including the proportion of the participant's investment to be invested into each of these funds. When the participant selects the custom election option 14, the processing means 20 is adapted to provide the information flow shown in functional block 24. The processing means 20 then does not provide for auto allocation or auto re-allocation. Preferably, the custom option 14 allows the participant to elect to step-up their deferral rate. The participant can select the percentage by which the deferral rate should be periodically stepped up and the number of years. If the participant elects for a step-up deferral, then the processing means 20 can process this election to provide an automatic step-up deferral.

If the participant elects the decline election 16 associated with enrollment form 10, then the processing means 20 need not perform any processing associated with the participant. It is, however, contemplated that should a participant decline participation in the group retirement plan, that the participant will be given additional reminders of the opportunity to enroll.

The present invention contemplates that the processing means is computer assisted. The present invention contemplates that any number of types of computerized processing systems can be used as would be well known in the art. The enrollment form can be either paper-based or electronic.

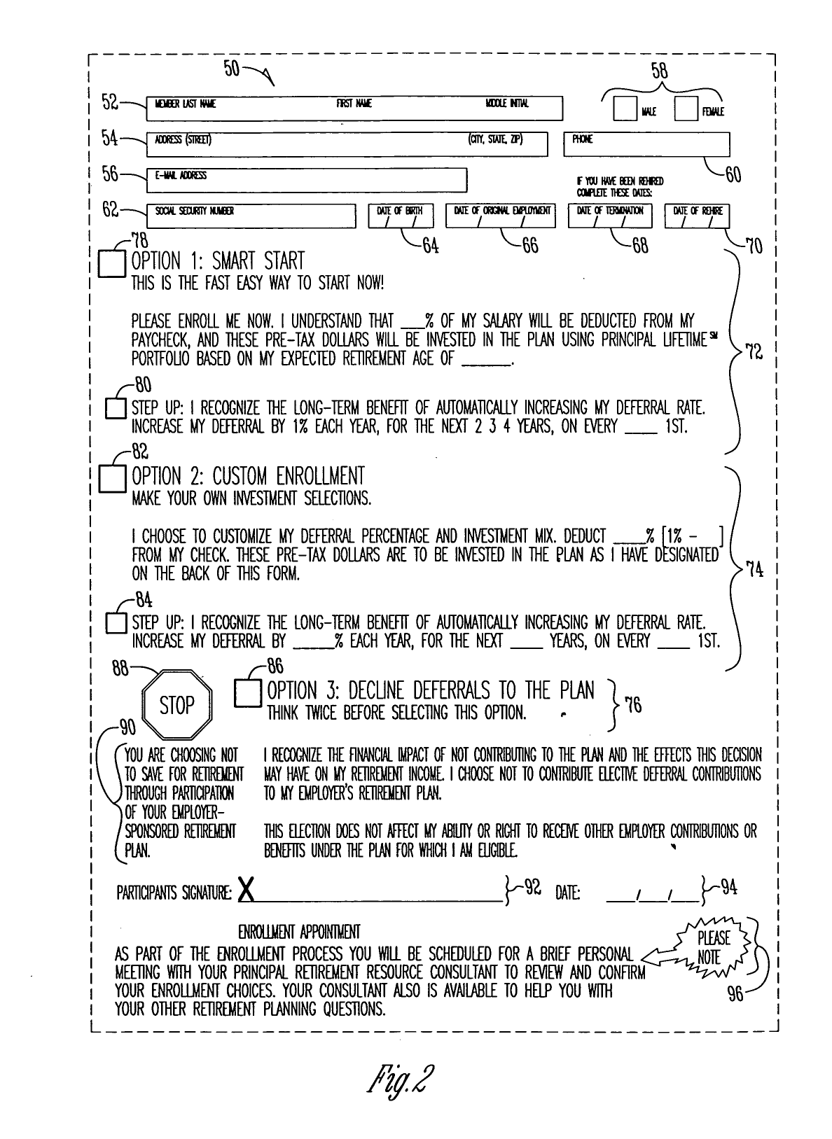

FIG. 2 illustrates one embodiment of an enrollment form according to the present invention. The enrollment form 50 includes an area for entering basic information about a participant. This can include a participant name input area 52, a participant gender input area 58, a participant address input area 54, a participant phone input area 60, a participant email address input area 56, a participant social security number input area 62, a participant date of birth input area 64, a participant date of original employment area 66, a participant date of termination input area 68, and a participant date of rehire input area 70. The present invention contemplates numerous variations in the specific personal information required. It is noted that a date of birth or a current age is used in the processing of the enrollment form according to certain embodiments of the present invention.

Enrollment form 50 also includes one or more options. A “smart start” option or convenience election option is provided and is selected by a participant by selecting the associated convenience election option box 78. This convenience election option 72 allows the participant to specify a percent of their salary to be deducted for investment. This percentage is typically called a deferral rate. Also, the participant enters their expected retirement age. A secondary option associated with the convenience election option is a step-up option 80 that allows a participant to elect to automatically increase their deferral rate by a certain amount such as 1%, on a periodic basis, such as every year and also the number of period (i.e. the number of years).

The enrollment form 50 also allows a participant to provide for specific investment selections by selecting the custom enrollment option 74, such as by checking the custom enrollment selection box 82. The participant would need to specify the specific funds and the percentage to invest in each fund in a separate form (not shown). The participant also elects a deferral rate. Also, the participant can select the step-up option box 84 and elect to increase their deferral by a particular percent or amount on a periodic basis. For example, a participant can elect to increase their deferral by a particular percentage each year for a particular number of years.

The enrollment form 50 also includes a third election option 76 whereby the participant declines deferrals to the plan by selecting the decline option box 86. There is a graphical cue 88 such as a stop sign associated with the decline option 76. The presence of the graphical cue 88 encourages a participant to elect to defer a portion of their salary to the retirement plan and not to decline contributing to the retirement plan. A verbal warning 90 is also associated with the decline option 76 to further discourage a participant from declining to participate in a group retirement plan. A signature line 92 and a date line 94 are also provided.

Preferably, the enrollment form 50 also includes a notice 96 that indicates that the participant should attend an appointment or meeting about group retirement plan so that they will have an opportunity to be better educated concerning the retirement plan and will have an opportunity to ask questions regarding the group retirement plan.

The present invention provides for processing the enrollment form 50 according to the elections made by the participant. The availability of the convenience election option requires additional processing as the date of birth of the participant and their expected retirement age are taken into account in selecting one or more investments for the participant.

The present invention contemplates numerous variations. The present invention contemplates variations in the manner in which the enrollment form is provided, including on paper, electronically, via the web, or through other implementations. The present invention contemplates numerous variations in the particular computer system used to provide the processing means. The present invention contemplates that the processing means can be implemented via computer, computer network, and one or more computers in any a number of topologies running any number of operating systems, user environments, and software. The present invention further contemplates variations in the particular group retirement plan used, the type of group retirement plan, the type of investment mix associated with the group retirement plan, and other variations. The present invention also contemplates use with any number of defined contribution plans and is not limited to group retirement plans. Moreover, it should be clear that that present invention contemplates use with any number of benefit plans offered on a voluntary enrollment basis, including, but not limited to voluntary life insurance, disability income insurance, dental insurance, and other specialty insurance programs. Those skilled in the art which the present invention pertains will recognize and be able to practice additional variations of the method and systems described and disclosed which fall within the broad teachings of the invention. Accordingly, all such modifications and additions are deemed to be within the spirit and scope of the invention.

1. A computer-assisted method of enrolling eligible employees in a group retirement plan to simplify election decisions necessary to enroll in the group retirement plan and encourage appropriate election decisions, comprising:
providing an enrollment form to an eligible employee;
providing a convenience election option associated with the enrollment form;
processing the enrollment form to enroll the eligible employees in the group retirement plan and where the convenience election option is selected, assigning a default deferral rate and automatically allocating retirement account funds of the eligible employees.

2. The method of claim 1 wherein the default deferral rate is selected to maximize employer matching contributions.

3. The method of claim 1 wherein the convenience election option provides for a step-up of the deferral rate on an annual basis.

4. The method of claim 1 wherein the convenience election option provides for automatic adjustment of allocation over time as the employee ages.

5. The method of claim 1 wherein the convenience election option provides for periodic rebalancing of the allocation.

6. The method of claim 1 providing a second election option associated with the enrollment form allowing the eligible employee to customize allocation of funds into a plurality of investment options.

7. The method of claim 6 further comprising providing a third election option associated with the enrollment form allowing the eligible employee not to enroll.

8. The method of claim 7 wherein the third election option is accompanied by a graphical cue to impress upon the eligible employee to think carefully before choosing not to save for retirement through participation in the group retirement plan.

9. The method of claim 8 wherein the graphical cue is a stop sign.

10. The method of claim 1 wherein the automatically allocating retirement account funds is partially based on expected retirement age.

11. A computer-assisted method of enrolling a participant in a retirement plan without receiving elections by the participant of investment options, comprising:
receiving a date of birth of the participant;
receiving an expected retirement age for the participant;
determining an allocation of investment including at least one investment option for the participant, the allocation based on the age of the date of birth of the participant and the expected retirement age of the participant;
investing funds of the participant according to the allocation;
automatically re-allocating the funds of the participant over time.

12. The method of claim 1 1 wherein the date of birth of the participant and the expected retirement age are provided by an enrollment form.

13. The method of claim 11 further comprising:
determining a deferral level to maximize contributions from a sponsor of the participant;
associating the deferral level with a convenience election on an enrollment form.

14. The method of claim 13 further comprising associating an annual step-up of deferral level with the convenience election.

15. The method of claim 11 wherein the at least one investment option includes stock holdings.

16. The method of claim 11 wherein the retirement plan is a 401(k) retirement plan.

17. A method of enrolling a participant in a group retirement plan to simplify election decisions necessary to enroll in the group retirement plan and encourage retirement saving through the group retirement plan, comprising:
providing an enrollment form to participants comprising a convenience election option whereby the participant selecting the convenience election option does not specify allocation of investments into funds;
processing the enrollment form to enroll the participant wherein the processing includes determining if the convenience election option is selected and where the convenience election option is selected, allocating funds of the participant based on age of the participant.

18. The method of claim 17 wherein the enrollment form includes a date of birth input area.

19. The method of claim 17 wherein the enrollment form includes a second election option whereby the participant specifies allocation of investments into funds.

20. The method of claim 19 wherein the enrollment form includes a third election option whereby the participant elects not to enroll.

21. The method of claim 20 wherein the third election option is associated with a graphical cue to discourage the participant from selecting the third election option.

22. The method of claim 21 wherein the graphical cue is a stop sign.

23. The method of claim 17 wherein the enrollment form further includes an appointment notice for informing the participant of availability of an educational opportunity regarding the group retirement plan.

24. The method of claim 17 wherein the enrollment form further includes a step-up deferral option associated with the convenience election option for the participant to elect to periodically increase a deferral rate.

25. The method of claim 24 wherein the step-up deferral option provides for an annual increase in the deferral rate.

26. The method of claim 24 wherein the deferral rate is associated with the convenience election option.

27. The method of claim 26 wherein the deferral rate is automatically selected to maximize contribution by a sponsor to a retirement account of the participant.

28. The method of claim 27 wherein the group retirement plan is a 401(k) plan.

29. The method of claim 27 wherein the group retirement plan is a defined contribution plan.

30. The method of claim 17 wherein the enrollment form is an electronic form.

31. A system for enrolling a participant in a group retirement plan to simplify election decisions necessary to enroll in the group retirement plan and encourage savings in a participant account within the group retirement plan, comprising:
an enrollment form comprising a convenience election option whereby the participant selecting the convenience election option does not specify allocation of investment into funds;
a processing means for processing information associated with the enrollment form, the processing means adapted for allocating investment by the participant into at least one fund based on date of birth of the participant and expected retirement age of the participant.

32. The system of claim 31 wherein the enrollment form is a paper form.

33. The system of claim 31 wherein the enrollment form includes a date of birth input area.

34. The system of claim 33 wherein the enrollment form includes a second election option whereby the participant specifies allocation of investment into funds.

35. The system of claim 34 wherein the enrollment form includes a third election option whereby the participant elects not to enroll.

36. The system of claim 35 wherein the third election option is associated with a graphical cue to discourage the participant from selecting the third election option.

37. The system of claim 36 wherein the graphical cue is a stop sign.

38. The system of claim 37 wherein the enrollment form further includes an appointment notice for informing the participant of availability of meeting regarding the group retirement plan.

39. The system of claim 31 wherein the enrollment form further includes a step-up deferral option associated with the convenience election option for the participant to elect to periodically increase a deferral rate.

40. The system of claim 39 wherein the step-up deferral option provides for an annual increase in the deferral rate.

41. The system of claim 31 wherein a deferral rate is associated with the convenience election option.

42. The system of claim 41 wherein the deferral rate is automatically selected to maximize contributions by a sponsor to a retirement account of the participant.

43. The system of claim 31 wherein the group retirement plan is a 401(k) plan.

44. The system of claim 31 wherein the group retirement plan is a defined contribution plan.

45. The system of claim 31 wherein the enrollment form is an electronic form.

46. A computer-assisted method of enrolling eligible employees in a voluntary enrollment benefit plan to simplify election decisions necessary to enroll in the voluntary enrollment benefit plan and encourage appropriate election decisions, comprising:
providing an enrollment form to an eligible employee;
providing a convenience election option associated with the enrollment form;
processing the enrollment form to enroll the eligible employees in the voluntary enrollment benefit plan and where the convenience election option is selected, assigning one or more default selections.

47. The computer-assisted method of claim 46 wherein at least one of the default selections is determined by an employee of the eligible employee.

48. The computer-assisted method of claim 46 further comprising providing a custom election option associated with the enrollment form to allow the eligible employee to make selections different from the one or more default selections.

49. The computer-assisted method of claim 46 wherein the voluntary enrollment benefit plan is an insurance plan.

50. The computer-assisted method of claim 46 wherein the voluntary enrollment benefit plan is a retirement plan.
